(19) United States
(12) Patent Application Publication
(10) Pub. No.: US 2014/0002633 A1
(43) Pub. Date: Jan. 2, 2014

(54) COMPONENT MOUNTER, HEAD, AND COMPONENT POSTURE RECOGNITION METHOD

(71) Applicant: Osamu Okuda, Osaka (JP)

(72) Inventor: Osamu Okuda, Osaka (JP)

(21) Appl. No.: 13/817,943

(22) PCT Filed: May 11, 2012
(86) PCT No.: PCT/JP2012/003110

§ 371 Date: Feb. 20, 2013

(30) Foreign Application Priority Data
Aug. 29, 2011 (JP) 2011-186572

(51) Int. Cl. H04N 7/18

(52) U.S. Cl. CPC H04N 7/183
USPC 348/87

(57) ABSTRACT

A component mounter includes: a head having a first illuminating unit disposed between a first nozzle and a second nozzle and which illuminates a side surface of a first component and a side surface of a second component with light, a first reflecting unit which reflects the light from the first illuminating unit off a first region and toward an imaging unit, and a second reflecting unit which reflects the light from the first illuminating unit off a second region and toward the imaging unit; and the imaging unit which captures an image of the first region in the first reflecting unit or the second region in the second reflecting unit to obtain an image of the side surface of the first component or the side surface of the second component.

### TECHNICAL FIELD

The present invention relates to a component mounter including a head having a nozzle for holding a component and an imaging unit for capturing an image of the component and which mounts the component on a board, the head, and a component posture recognition method.

### BACKGROUND ART

Component mounters which hold components using nozzles and mount the components on boards are known. In such a component mounter, it is important to accurately recognize a posture of a component held by a nozzle in order to accurately mount the component on a board.

Conventionally, a component mounter is disclosed which is capable of recognizing a posture of a component being held by a nozzle (for example, refer to Patent Literature (PTL) 1 to 3).

In a component mounter disclosed in PTL 1, a nozzle is moved up and down for measuring the thickness of a component. Accordingly, the shape of the component seen from the side direction can be recognized from the thickness of the component, and thus the posture of the component can be recognized.

In a component mounter disclosed in PTL 2, a line sensor is provided for a head, and an image of a component held by a nozzle is captured by the line sensor from the side direction. Accordingly, the shape of the component seen from the side direction can be recognized from the image captured by the line sensor, and thus the posture of the component can be recognized.

In a component mounter disclosed in PTL 3, a camera is provided for a head, and an image of a component held by a nozzle is captured by the camera from the side direction. Accordingly, the shape of the component seen from the side direction can be recognized from the image captured by the camera, and thus the posture of the component can be recognized.

### CITATION LIST

### Patent Literature

[PTL 1] Japanese Unexamined Patent Application Publication No. 2010-114340
[PTL 2] Japanese Patent No. 4675833
[PTL 3] Japanese Unexamined Patent Application Publication No. 2005-101211

### SUMMARY OF INVENTION

### Technical Problem

However, in a conventional component mounter, the recognition of the posture of a component takes time, thereby causing a tact loss. Here, the tact loss refers to a loss in mounting time (tact time) for mounting predetermined components on a board.

That is, in the component mounter disclosed in PTL 1, it is necessary to move the nozzle up and down for recognizing the posture of the component, thereby requiring time for moving the nozzle up and down and causing a tact loss.

Moreover, in the component mounters disclosed in PTL 1 and 2, since the line sensor or the camera is provided for the head, the weight of the head is increased. Therefore, the transportation of the head takes time, thereby causing a tact loss. Moreover, since the line sensor or the camera is provided for the head, the structure is complicated.

The present invention was conceived in view of the above problems and has an object to provide a component mounter, a head, and a component posture recognition method which enables, with a simple structure, recognition of a posture of a component while suppressing a tact loss.

### Solution to Problem

In order to achieve the aforementioned object, a component mounter according to the present invention is a component mounter which mounts a first component and a second component on a board, the component mounter including: a head including a first nozzle for holding the first component and a second nozzle for holding the second component; and an imaging unit which captures an image of the first component and an image of the second component, in which the head includes: a first illuminating unit disposed between the first nozzle and the second nozzle and which illuminates a side surface of the first component and a side surface of the second component with light; a first reflecting unit disposed lateral to the first nozzle such that the first nozzle is positioned between the first illuminating unit and the first reflecting unit and which reflects the light from the first illuminating unit, the light reflected off a first region of the first reflecting unit and toward the imaging unit; and a second reflecting unit disposed lateral to the second nozzle such that the second nozzle is positioned between the first illuminating unit and the second reflecting unit and which reflects the light from the first illuminating unit, the light reflected off a second region of the second reflecting unit and toward the imaging unit, and the imaging unit which captures an image of the first region in the first reflecting unit or the second region in the second reflecting unit to obtain an image of the side surface of the first component or the side surface of the second component.

Accordingly, in the component mounter, the first illuminating unit illuminates the side surface of the first component and the side surface of the second component with light, the first region in the first reflecting unit or the second region in the second reflecting unit reflects the light, and the imaging unit captures the image of the first region or the second region to obtain the image of the side surface of the first component or the side surface of the second component. With this, since the image of the side surface of the first component or the side surface of the second component can be captured from below using the first illuminating unit and the first reflecting unit or the second reflecting unit, it is not necessary to provide the imaging unit for the head. Moreover, there is no need to move the nozzle up and down when capturing the image of the side surface of the first component or the side surface of the second component. Accordingly, with the component mounter, it is possible to recognize a posture of a component, with a simple structure, while suppressing a tact loss.

Moreover, it is preferable that the component mounter further includes: a second illuminating unit which illuminates a third region including at least one of a bottom surface of the first component and a bottom surface of the second component; and an illumination controlling unit which causes the first illuminating unit and the second illuminating unit to start illumination or to stop illumination, in which the illumination controlling unit (a) causes the first illuminating unit to be in an illuminating state and causes the second illuminating unit to be in a non-illuminating state when the imaging unit captures the image of the first region or the second region; and (b) causes the second illuminating unit to be in an illuminating state and causes the first illuminating unit to be in a non-illuminating state when the imaging unit captures an image of the third region.

Accordingly, when the imaging unit captures the image of the first region or the second region, the component mounter causes the first illuminating unit to be in an illuminating state and causes the second illuminating unit to be in a non-illuminating state to capture the image of the side surface of the first component or the side surface of the second component. Moreover, when the imaging unit captures the image of the third region, the component mounter causes the second illuminating unit to be in an illuminating state and causes the first illuminating unit to be in a non-illuminating state to capture an image of at least one of the bottom surface of the first component and the bottom surface of the second component. That is, the image of the side surface of the component can be captured using the imaging unit that is provided for the purpose of capturing the image of the bottom surface of the component. Moreover, by selectively using the illuminating units necessary for capturing the image, the image of the side surface and the image of the bottom surface of the component can be captured using one imaging unit 210. Accordingly, with the component mounter, it is possible to recognize a posture of a component, with a simple structure, while suppressing a tact loss.

Moreover, it is preferable that the component mounter further includes: a head transportation controlling unit which transports the head; and an imaging controlling unit which causes the imaging unit to capture an image, in which, when the head transportation controlling unit transports the head to place the first region above the imaging unit, the illumination controlling unit causes the first illuminating unit to illuminate the first region and cause the second illuminating unit to maintain a non-illuminating state or to stop illumination, and the imaging controlling unit causes the imaging unit to capture the image of the first region, when the head transportation controlling unit transports the head to place the third region above the imaging unit, the illumination controlling unit causes the second illuminating unit to illuminate the third region and cause the first illuminating unit to stop illumination, and the imaging controlling unit causes the imaging unit to capture the image of the third region, and when the head transportation controlling unit transports the head to place the second region above the imaging unit, the illumination controlling unit causes the first illuminating unit to illuminate the second region and cause the second illuminating unit to stop illumination, and the imaging controlling unit causes the imaging unit to capture the image of the second region.

Accordingly, in the component mounter, when the head is transported to place the first region above the imaging unit, the first illuminating unit illuminates the first region and the second illuminating unit maintains the non-illuminating state or stops the illumination, and the imaging unit captures the image of the first region. Moreover, in the component mounter, when the head is transported to place the third region above the imaging unit, the second illuminating unit illuminates the third region, the first illuminating unit stops the illumination, and the imaging unit captures the image of the third region. Moreover, in the component mounter, when the head is transported to place the second region above the imaging unit, the first illuminating unit illuminates the second region, the second illuminating unit stops the illumination, and the imaging unit captures the image of the second region. That is, in the component mounter, the head is transported and the images of the side surface of the first component, the bottom surface of the first component, the bottom surface of the second component, and the side surface of the second component are sequentially captured. Here, if an image of the side surfaces and the bottom surfaces of the first component and the second component are simultaneously captured, a viewing field is increased and the illumination light is polarized, resulting in a decrease in an imaging accuracy. Therefore, by sequentially capturing the images of the side surfaces and the bottom surfaces of the first component and the second component, the imaging accuracy can be improved. Moreover, transportation of the head within intervals of the capturing period of the imaging unit does not generate a tact loss that can be caused by the transportation of the head. Accordingly, with the component mounter, it is possible to accurately recognize a posture of a component, with a simple structure, while suppressing a tact loss.

Moreover, it is preferable that the component mounter further includes an opaque and non-reflective member disposed between the first illuminating unit and the imaging unit, the member being opaque for blocking transmission of light from the first illuminating unit, and non-reflective for blocking reflection of light toward the first illuminating unit.

Accordingly, the component mounter includes the opaque and non-reflective member disposed between the first illuminating unit and the imaging unit, the member being opaque for blocking transmission of light from the first illuminating unit, and non-reflective for blocking reflection of light toward the first illuminating unit. That is, with the member, it is possible to prevent the light from the first illuminating unit from directly entering the imaging unit and to prevent the light from being reflected by the first illuminating unit and entering the imaging unit. Thus, in the component mounter, the imaging unit is capable of accurately capturing the image of the component. Therefore, it is possible to accurately recognize a posture of a component, with a simple structure, while suppressing a tact loss.

Moreover, it is preferable that the component mounter further includes a component supplying unit including components and which supplies the components to the head; and an imaging transportation controlling unit which transports the imaging unit along the component supplying unit, in which the imaging transportation controlling unit transports the imaging unit close to a position at which the head has picked up or picks up a component using suction from the component supplying unit.

Accordingly, in the component mounter, the imaging unit is transported close to the position at which the head has picked up or picks up the component using suction from the component supplying unit. With this, in the component mounter, it is possible to transport the head above the imaging unit in a short period of time after the head picks up the component from the component supplying unit and to cause the imaging unit to capture the image of the component picked up by the head. Accordingly, it is possible, with a simple structure, to recognize a posture of a component while suppressing a tact loss. Moreover, after the head mounts the component on the board, the head can be transported above the imaging unit in the middle of the transportation for picking up a component and to cause the imaging unit to capture an image of the suctioning state for the component to the head. In particular, although a recognition error may be caused by solder and others which is attached to a tip of the nozzle when the head mounts the component on the board, the recognition error can be prevented by causing the imaging unit to capture the image of the suctioning state for the component. Accordingly, it is possible, with a simple structure, to recognize a posture of a component while suppressing a tact loss.

Moreover, in order to achieve the aforementioned object, a head according to the present invention is a head which includes a first nozzle for holding a first component and a second nozzle for holding a second component and is provided in a component mounter which captures an image of the first component and an image of the second component using an imaging unit and mounts the first component and the second component on a board, the head including: a first illuminating unit disposed between the first nozzle and the second nozzle and which illuminates a side surface of the first component and a side surface of the second component with light; a first reflecting unit disposed lateral to the first nozzle such that the first nozzle is positioned between the first illuminating unit and the first reflecting unit and which reflects the light from the first illuminating unit, the light reflected off a first region of the first reflecting unit and toward the imaging unit; and a second reflecting unit disposed lateral to the second nozzle such that the second nozzle is positioned between the first illuminating unit and the second reflecting unit and which reflects the light from the first illuminating unit, the light reflected off a second region of the second reflecting unit and toward the imaging unit.

Accordingly, in the head, the first illuminating unit illuminates the side surface of the first component and the side surface of the second component with light, and the light is reflected off the first region in the first reflecting unit or the second region of the second reflecting unit. With this, since the image of the side surface of the first component or the side surface of the second component can be obtained by capturing the image of the first region or the second region by the imaging unit, it is not necessary to provide the imaging unit for the head. Moreover, there is no need to move the nozzle up and down when capturing the image of the side surface of the first component or the side surface of the second component. Accordingly, use of the head enables a component mounter to be capable of, with a simple structure, recognizing a posture of a component while suppressing a tact loss.

Moreover, in order to achieve the aforementioned object, a component posture recognition method according to the present invention is a method in which a component mounter recognizes postures of a first component and a second component, the component mounter including a head having a first nozzle for holding the first component and a second nozzle for holding the second component, and an imaging unit which captures an image of the first component and an image of the second component, the method including: (a) causing a first illuminating unit to illuminate a side surface of the first component with light to cause a first reflecting unit to reflect the light from the first illuminating unit, the light reflected off a first region of the first reflecting unit and toward the imaging unit, the first illuminating unit being disposed between the first nozzle and the second nozzle, and the first reflecting unit being disposed lateral to the first nozzle such that the first nozzle is positioned between the first illuminating unit and the first reflecting unit; (b) causing the imaging unit to capture an image of the first region in the first reflecting unit to obtain an image of the side surface of the first component; (c) causing the first illuminating unit to illuminate a side surface of the second component with light to cause a second reflecting unit to reflect the light from the first illuminating unit, the light reflected off a second region of the second reflecting unit and toward the imaging unit, and the second reflecting unit being disposed lateral to the second nozzle such that the second nozzle is positioned between the first illuminating unit and the second reflecting unit; and (d) causing the imaging unit to capture an image of the second region in the second reflecting unit to obtain an image of the side surface of the second component.

Accordingly, the first illuminating unit illuminates the side surface of the first component and the side surface of the second component with light, the first region in the first reflecting unit or the second region in the second reflecting unit reflects the light, and the imaging unit captures the image of the first region or the second region to obtain the image of the side surface of the first component or the side surface of the second component. With this, since the image of the side surface of the first component or the side surface of the second component can be captured from below using the first illuminating unit and the first reflecting unit or the second reflecting unit, it is not necessary to provide the imaging unit for the head. Moreover, there is no need to move the nozzle up and down when capturing the image of the side surface of the first component or the side surface of the second component. Thus, with the component posture recognition method, it is possible to recognize the posture of the component while suppressing a tact loss using the component mounter having a simple structure.

Moreover, it is preferable that the component posture recognition method further includes transporting the head to place the first region above the imaging unit, in which step (a) includes causing the first illuminating unit to illuminate the first region and causing a second illuminating unit which illuminates a third region including at least one of a bottom surface of the first component and a bottom surface of the second component to maintain a non-illuminating state or to stop illumination, and the component posture recognition method further includes: transporting the head to place the third region above the imaging unit; causing the second illuminating unit to illuminate the third region and causing the first illuminating unit to stop illumination; causing the imaging unit to capture an image of the third region; and transporting the head to place the second region above the imaging unit, in which step (c) includes causing the first illuminating unit to illuminate the second region and causing the second illuminating unit to stop illumination.

Accordingly, the head is transported to place the first region above the imaging unit, the first illuminating unit illuminates the first region and the second illuminating unit maintains the non-illuminating state or stops the illumination, and the imaging unit captures the image of the first region. Moreover, the head is transported to place the third region above the imaging unit, the second illuminating unit illuminates the third region, the first illuminating unit stops the illumination, and the imaging unit captures the image of the third region. Moreover, the head is transported to place the second region above the imaging unit, the first illuminating unit illuminates the second region, the second illuminating unit stops the illumination, and the imaging unit captures the image of the second region. That is, the head is transported and the images of the side surface of the first component, the bottom surface of the first component, the bottom surface of the second component, and the side surface of the second component are sequentially captured. Here, if an image of the side surfaces and the bottom surfaces of the first component and the second component are simultaneously captured, a viewing field is increased and the illumination light is polarized, resulting in a decrease in an imaging accuracy. Therefore, by sequentially capturing the images of the side surfaces and the bottom surfaces of the first component and the second component, the imaging accuracy can be improved. Moreover, transportation of the head within the intervals of the capturing period of the imaging unit does not generate a tact loss that can be caused by the transportation of the head. Thus, with the component posture recognition method, it is possible to recognize the posture of the component while suppressing a tact loss using the component mounter having a simple structure.

It is to be noted that the present invention can be implemented not only as such a component posture recognition method, but as a program for causing a computer to execute the characteristic processes included in the component posture recognition method or as an integrated circuit. Such a program can naturally be distributed through recording media such as CD-ROMs or via communication media such as the Internet.

### Advantageous Effects of Invention

According to the present invention, a component mounter can be provided which has a simple structure and is capable of recognizing a posture of a component while suppressing a tact loss.

### BRIEF DESCRIPTION OF DRAWINGS

FIG. 1 is an outer view showing a structure of a component mounter according to an embodiment of the present invention.

FIG. 2 is a plan view showing a main internal structure of the component mounter according to the embodiment of the present invention.

FIG. 3 is a diagram showing structures of a head and an imaging device according to the embodiment of the present invention.

FIG. 4 is a diagram showing a detailed structure of the head according to the embodiment of the present invention.

FIG. 5 is a block diagram showing a functional configuration of a controlling device according to the embodiment of the present invention.

FIG. 6 is a flowchart showing processes in which the controlling device according to the embodiment of the present invention recognizes a posture of a component.

FIG. 7 is a diagram for illustrating processes in which an imaging transportation controlling unit according to the embodiment of the present invention transports an imaging unit.

FIG. 8A is a diagram for illustrating processes in which the head transportation controlling unit according to the embodiment of the present invention transports the head to place a first region above the imaging unit.

FIG. 8B is a diagram for illustrating processes in which the head transportation controlling unit according to the embodiment of the present invention transports the head to place the first region above the imaging unit.

FIG. 9A is a diagram for illustrating processes in which the head transportation controlling unit according to the embodiment of the present invention transports the head to place a third region above the imaging unit.

FIG. 9B is a diagram for illustrating processes in which the head transportation controlling unit according to the embodiment of the present invention transports the head to place the third region above the imaging unit.

FIG. 10A is a diagram for illustrating processes in which the head transportation controlling unit according to the embodiment of the present invention transports the head to place a second region above the imaging unit.

FIG. 10B is a diagram for illustrating processes in which the head transportation controlling unit according to the embodiment of the present invention transports the head to place the second region above the imaging unit.

### DESCRIPTION OF EMBODIMENTS

Hereinafter, a component mounter according to an embodiment of the present invention will be described with reference to the drawings.

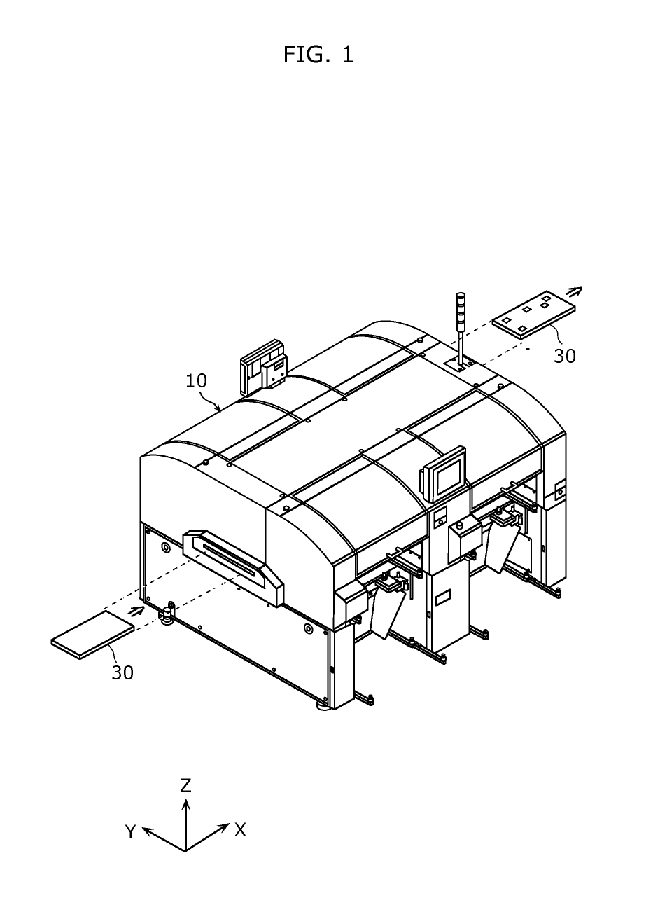

FIG. 1 is an outer view showing a structure of a component mounter 10 according to the embodiment of the present invention.

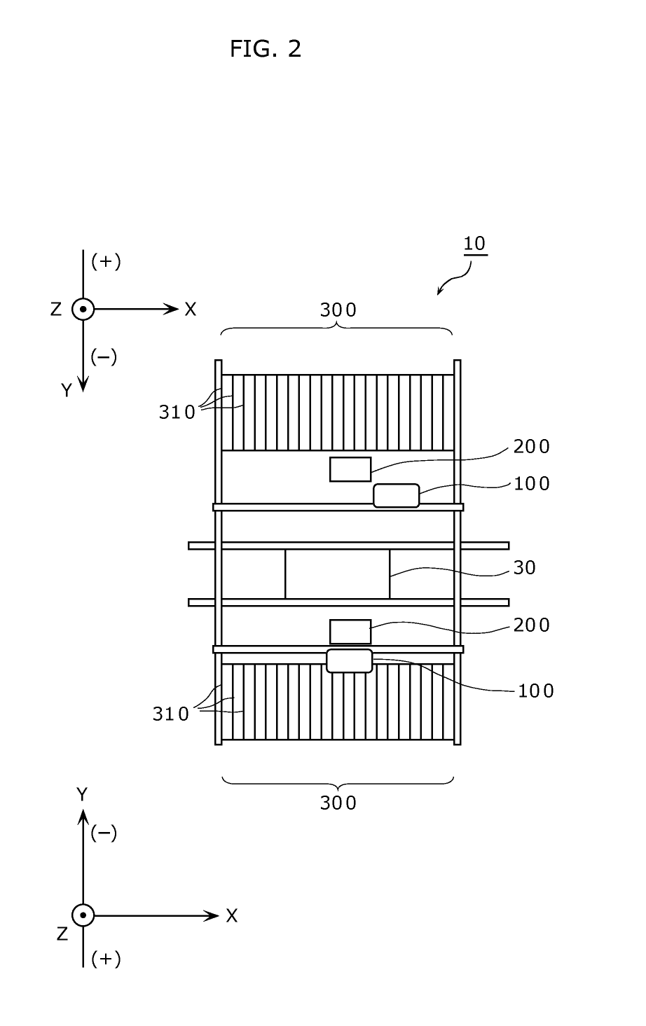

FIG. 2 is a plan view showing a main internal structure of the component mounter 10 according to the embodiment of the present invention.

As shown in FIG. 1, the component mounter 10 mounts components on a board 30 to manufacture a mounted board, and includes a controlling device 20 (not shown) therein. The controlling device 20 is a computer for controlling an operation of the component mounter 10. Details of the controlling device 20 will be described later. It is to be noted that the controlling device 20 do not need to be provided inside the component mounter 10, but may be a computer such as a personal computer disposed outside the component mounter 10.

Moreover, as shown in FIG. 2, the component mounter 10 includes two mounting units for mounting the components on the board 30. The two mounting units operate together to mount the components, for example, on one board 30. Each of the mounting units includes a head 100, an imaging device 200, and a component supplying unit 300.

The component supplying unit 300 includes a series of component feeders 310 each containing a component tape. It is to be noted that the component tape is, for example, supplied in a state as follows: plural components of the same type are aligned at even intervals on a tape (carrier tape); and the tape is wound on, for example, a reel. Moreover, examples of the components aligned in the component tape include a BGA and a chip component.

The head 100 including plural nozzles picks up components in the component tape contained in the component feeders 310 using suction by corresponding nozzles, transports the picked-up components over the board 30, and mounts the components on the board 30. It is to be noted that details of the nozzles will be described later.

Moreover, in the diagram, a direction from the component supplying unit 300 toward the board 30 positioned at the center of the Y axis direction is defined as the Y axis minus direction.

The imaging device 200 captures an image of a component held by the head 100 from below the component, and is used for recognizing the component. Specifically, the imaging device 200 captures the image of the component picked up by the nozzle of the head 100, and examines the state of the suctioning for the component two-dimensionally or three-dimensionally. It is to be noted that details of the controlling device 200 will be described later.

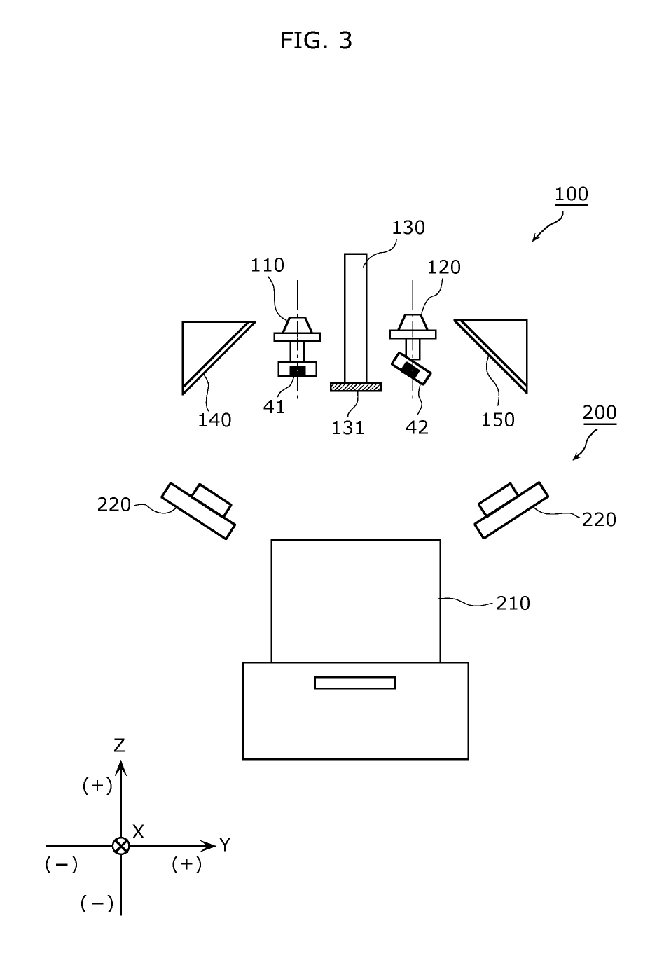

FIG. 3 is a diagram showing structures of the head 100 and the imaging device 200 according to the embodiment of the present invention.

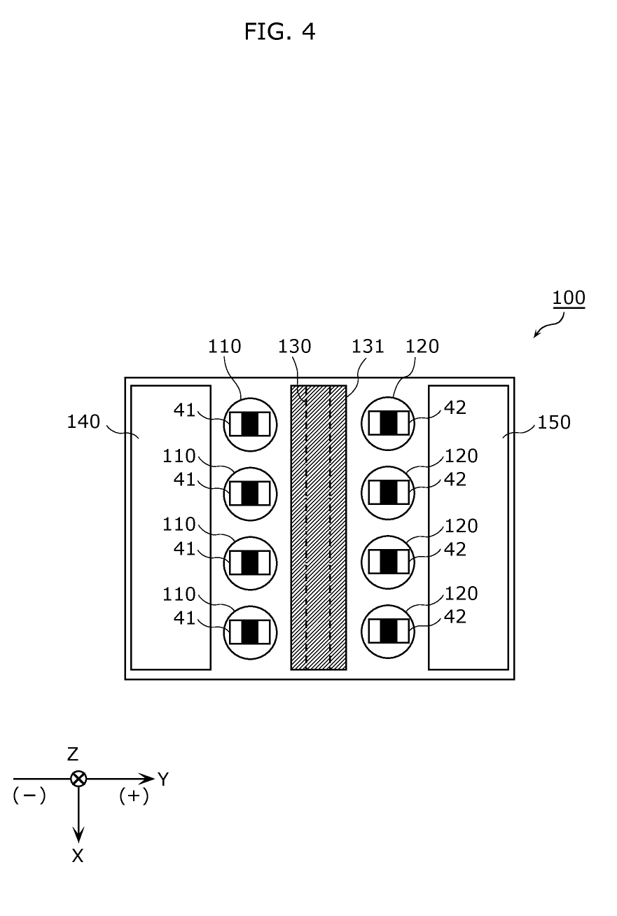

FIG. 4 is a diagram showing a detailed structure of the head 100 according to the embodiment of the present invention. Specifically, FIG. 4 is a diagram of the head 100 shown in FIG. 3 seen from below (the Z axis minus side).

As shown in these diagrams, the head 100 includes first nozzles 110, second nozzles 120, a first illuminating unit 130, a blocking plate 131, a first reflecting unit 140, and a second reflecting unit 150. Moreover, the imaging device 200 includes an imaging unit 210 and a second illuminating unit 220.

The first nozzles 110 are nozzles for holding first components 41. In the case of this embodiment, the first nozzles 110 are nozzles for holding the first components 41 using vacuum suction.

Specifically, the first nozzles 110 are positioned at the Y axis minus side of the first illuminating unit 130 in the diagram, and in this embodiment, the first nozzles 110 includes four nozzles aligned in the X axis direction as shown in FIG. 4. It is to be noted that the first components 41 held by the first nozzles 110 may be components of different types for each nozzle, or may be components of the same type. Moreover, the number of nozzles is not limited to four.

The second nozzles 120 are nozzles for holding second components 42. In the case of this embodiment, the second nozzles 120 are for holding the second components 42 using vacuum suction.

Specifically, the second nozzles 120 are positioned at the Y axis plus side of the first illuminating unit 130, and in this embodiment, the second nozzles 120 include four nozzles aligned in the X axis direction corresponding to the first nozzles 110 as shown in FIG. 4. It is to be noted that the second components 42 held by the second nozzles 120 may be components of different types for each nozzle, or may be components of the same type. Moreover, the number of nozzles is not limited to four.

The first illuminating unit 130 is positioned between the first nozzles 110 and the second nozzles 120, and illuminates the side surface of each of the first components 41 and the side surface of each of the second components 42. That is, the first illuminating unit 130 is an illumination for emitting light both in the Y axis minus direction and the Y axis plus direction. It is to be noted that it is sufficient that the side surface of the first component 41 and the side surface of the second component 42 are illuminated by means of the first illuminating unit 130, and the first illuminating unit 130 needs not to emit light by itself.

The blocking plate 131 is a plate-shaped member positioned between the first illuminating unit 130 and the imaging unit 210. Specifically, the blocking plate 131 is an opaque and non-reflective member which is opaque for blocking transmission of light from the first illuminating unit 130, and non-reflective for blocking reflection of light toward the first illuminating unit 130.

That is, the blocking plate 131 is an opaque member so as not to allow the light from the first illuminating unit 130 to enter the imaging unit 210. Moreover, the blocking plate 131 is a non-reflective member so as to prevent light from the second illuminating unit 220 and others from being reflected by the first illuminating unit 130 and entering the imaging unit 210. It is to be noted that the blocking plate 131 is not limited to be plate-shaped.

The first reflecting unit 140 is a mirror positioned lateral to the first nozzles 110 such that the first nozzles 110 are positioned between the first reflecting unit 140 and the first illuminating unit 130. Moreover, the first reflecting unit 140 reflects the light from the first illuminating unit 130 off a first region and toward the imaging unit 210.

Specifically, the first reflecting unit 140 is positioned at the Y axis minus side of the first nozzle 110 facing obliquely downward, and reflects the light from the first illuminating unit 130 off the first region and downward (in the Z axis minus direction). Here, the first region is a region in a surface of the first reflecting unit 140 facing the first illuminating unit 130 (a surface facing obliquely downward).

The second reflecting unit 150 is a mirror positioned lateral to the second nozzles 120 such that the second nozzles 120 are positioned between the second reflecting unit 150 and the first illuminating unit 130. Moreover, the second reflecting unit 150 reflects the light from the first illuminating unit 130 off a second region and toward the imaging unit 210.

Specifically, the second reflecting unit 150 is positioned at the Y axis plus side of the second nozzle 120 facing obliquely downward, and reflects the light from the first illuminating unit 130 off the second region and downward (in the Z axis minus direction). Here, the second region is a region in a surface of the second reflecting unit 150 facing the first illuminating unit 130 (a surface facing obliquely downward).

The imaging unit 210 is a camera for capturing an image of the first component 41 and an image of the second component 42. In this embodiment, the imaging unit 210 is an area camera such as a stroboscopic shutter camera which is capable of capturing an image of a predetermined rectangular region. It is to be noted that the imaging unit 210 may be another type of camera such as a line camera which is capable of capturing an image of a linear region.

Specifically, the imaging unit 210 captures an image of the bottom surface of the first component 41 and an image of the bottom surface of the second component 42 from below (the Z axis minus side of) the head 100. Moreover, the imaging unit 210 captures an image of the side surface of the first component 41 or the side surface of the second component 42 by capturing an image of the first region in the first reflecting unit 140 or the second region in the second reflecting unit 150.

The second illuminating unit 220 illuminates the third region including at least one of the bottom surface of the first component 41 and the bottom surface of the second component 42. Specifically, the second illuminating unit 220 includes two illuminations disposed obliquely below the first component 41 and the second component 42. One of the illuminations illuminates the bottom surface of the first component 41 and the other one illuminates the bottom surface of the second component 42. It is to be noted that it is sufficient that the third region is illuminated by means of the second illuminating unit 220, and the second illuminating unit 220 needs not emit light by itself.

Next, the controlling device 20 included in the component mounter 10 will be described in detail.

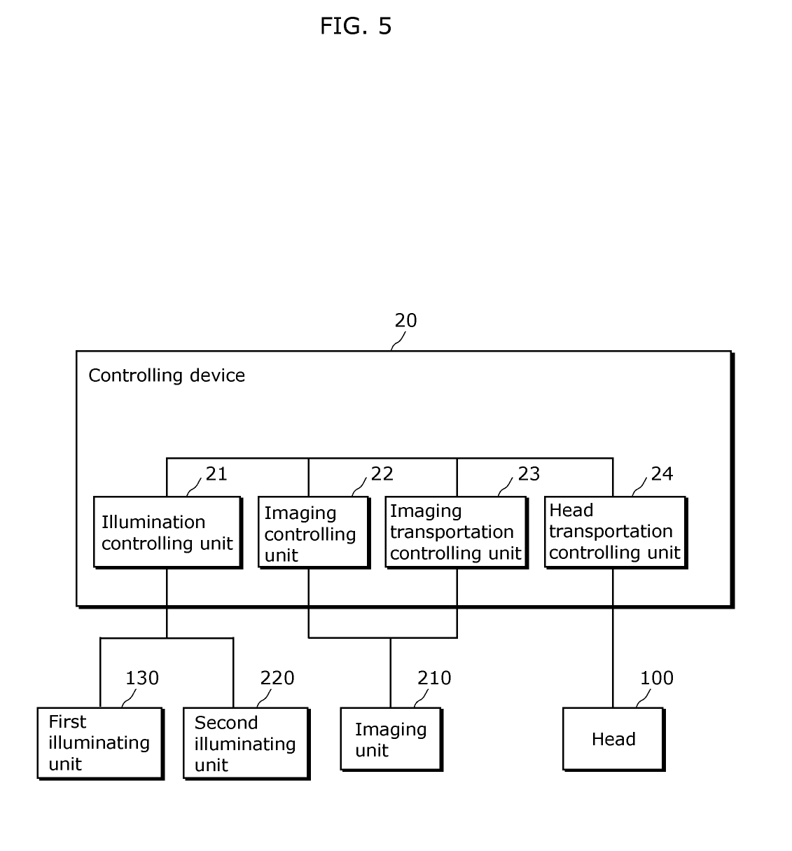

FIG. 5 is a block diagram showing a functional configuration of the controlling device 20 according to the embodiment of the present invention.

The controlling device 20 is for controlling recognition of the posture of the component held by the head 100. As shown in the diagram, the controlling device 20 includes an illumination controlling unit 21, an imaging controlling unit 22, an imaging transportation controlling unit 23, and a head transportation controlling unit 24.

The head transportation controlling unit 24 is a processing unit for transporting the head 100. Specifically, the head transportation controlling unit 24 transports the head 100 to place the first region above the imaging unit 210, to place the third region above the imaging unit 210, and to place the second region above the imaging unit 210.

The illumination controlling unit 21 is a processing unit for causing the first illuminating unit 130 and the second illuminating unit 220 to start illumination and thus to be in an illuminating state or to stop illumination and thus to be in a non-illuminating state. Specifically, the illumination controlling unit 21 causes the first illuminating unit 130 to be in an illuminating state and causes the second illuminating unit 220 to maintain a non-illuminating state or to be in a non-illuminating state when the imaging unit 210 captures the image of the first region or the second region.

Specifically, the illumination controlling unit 21 causes the first illuminating unit 130 to illuminate the first region and causes the second illuminating unit 220 to maintain the non-illuminating state or to stop illumination when the head transportation controlling unit 24 transports the head 100 to place the first region above the imaging unit 210. That is, the illumination controlling unit 21 causes the first illuminating unit 130 to illuminate the side surface of the first component 41 with light to cause the light from the first illuminating unit 130 to be reflected by the first region in the first reflecting unit 140 toward the imaging unit 210.

Moreover, the illumination controlling unit 21 causes the first illuminating unit 130 to illuminate the second region and causes the second illuminating unit 220 to stop illumination when the head transportation controlling unit 24 transports the head 100 to place the second region above the imaging unit 210. That is, the illumination controlling unit 21 causes the first illuminating unit 130 to illuminate the side surface of the second component 42 with light to cause the light from the first illuminating unit 130 to be reflected by the second region in the second reflecting unit 150 toward the imaging unit 210.

Moreover, the illumination controlling unit 21 causes the second illuminating unit 220 to be in an illuminating state and causes the first illuminating unit 130 to be in a non-illuminating state when the imaging unit 210 captures an image of the third region. Specifically, the illumination controlling unit 21 causes the second illuminating unit 220 to illuminate the third region and causes the first illuminating unit 130 to stop illumination when the head transportation controlling unit 24 transports the head 100 to place the third region above the imaging unit 210.

The imaging controlling unit 22 is a processing unit for causing the imaging unit 210 to capture an image. That is, the imaging controlling unit 22 causes the imaging unit 210 to capture an image of the first region in the first reflecting unit 140 to obtain an image of the side surface of the first component 41. Moreover, the imaging controlling unit 22 causes the imaging unit 210 to capture an image of the second region in the second reflecting unit 150 to obtain an image of the side surface of the second component 42.

Specifically, when the head transportation controlling unit 24 transports the head 100 to place the first region above the imaging unit 210 and the illumination controlling unit 21 causes the first illuminating unit 130 to illuminate the first region and causes the second illuminating unit 220 to maintain the non-illuminating state or to stop illumination, the imaging controlling unit 22 causes the imaging unit 210 to capture the image of the first region.

Moreover, when the head transportation controlling unit 24 transports the head 100 to place the third region above the imaging unit 210 and the illumination controlling unit 21 causes the second illuminating unit 220 to illuminate the third region and causes the first illuminating unit 130 to stop the illumination, the imaging controlling unit 22 causes the imaging unit 210 to capture the image of the third region.

Moreover, when the head transportation controlling unit 24 transports the head 100 to place the second region above the imaging unit 210 and the illumination controlling unit 21 causes the first illuminating unit 130 to illuminate the second region and causes the second illuminating unit 220 to stop the illumination, the imaging controlling unit 22 causes the imaging unit 210 to capture the image of the second region.

The imaging transportation controlling unit 23 is a processing unit for transporting the imaging unit 210 along the component supplying unit 300. Specifically, the imaging transportation controlling unit 23 transports the imaging unit 210 close to a position at which the head 100 has picked up or picks up a component from the component supplying unit 300.

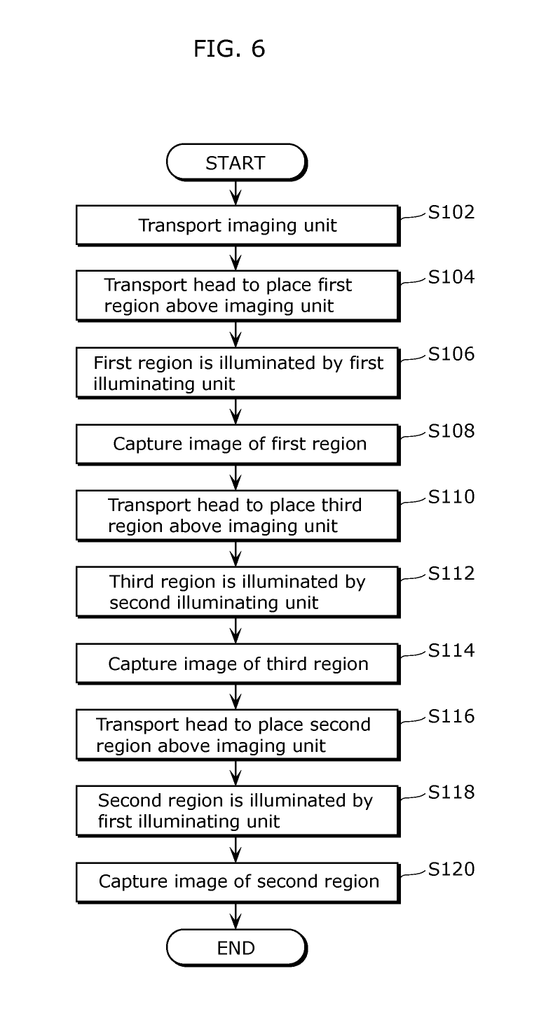

Next, processes in which the controlling device 20 recognizes the posture of the component held by the head 100 will be described in detail with reference to FIGS. 6 to 10B.

FIG. 6 is a flowchart showing processes in which the controlling device 20 according to the embodiment of the present invention recognizes the posture of the component.

First, as shown in FIG. 6, the imaging transportation controlling unit 23 transports the imaging unit 210 along the component supplying unit 300 (S102).

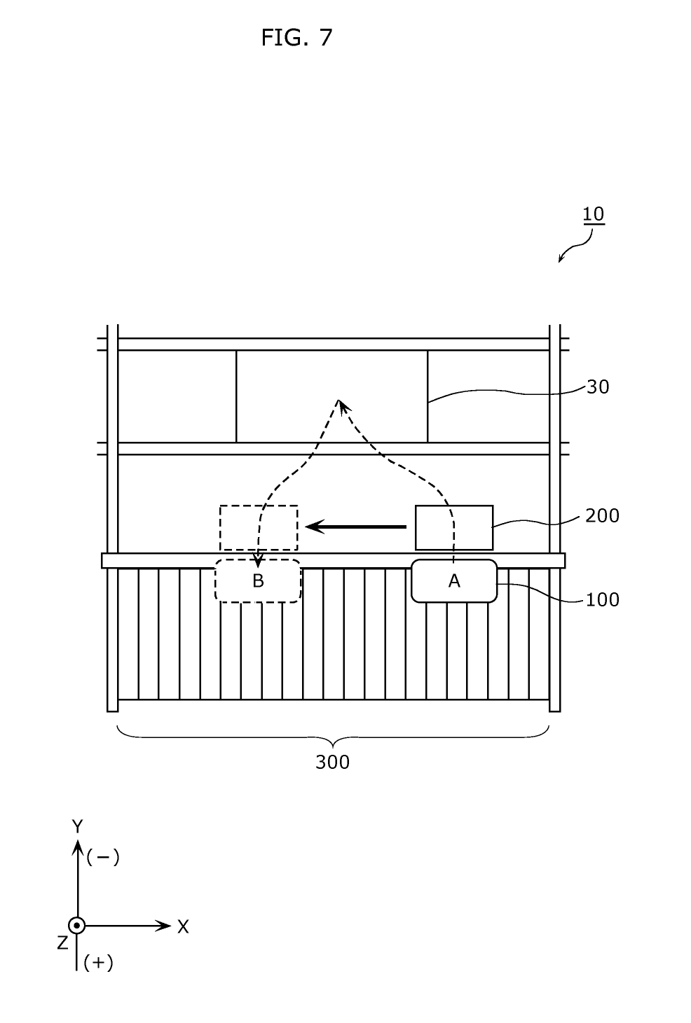

FIG. 7 is a diagram for illustrating processes in which the imaging transportation controlling unit 23 according to the embodiment of the present invention transports imaging unit 210.

Moreover, in the diagram, a direction from the component supplying unit 300 toward the board 30 that is positioned at the center of a Y axis direction is defined as the Y axis minus direction.

As shown in the diagram, when the head 100 has picked up a component from the component supplying unit 300, the imaging transportation controlling unit 23 transports the imaging device 200 close to a position at which the head 100 has picked up the component (the position A in the diagram).

Moreover, when the head 100 moves to pick up a component after mounting the component on the board 30, the imaging transportation controlling unit 23 transports the imaging device 200 close to a position at which the head 100 picks up a component (the position B in the diagram).

Next, turning back to FIG. 6, the head transportation controlling unit 24 transports the head 100 to place the first region above the imaging unit 210 (S104).

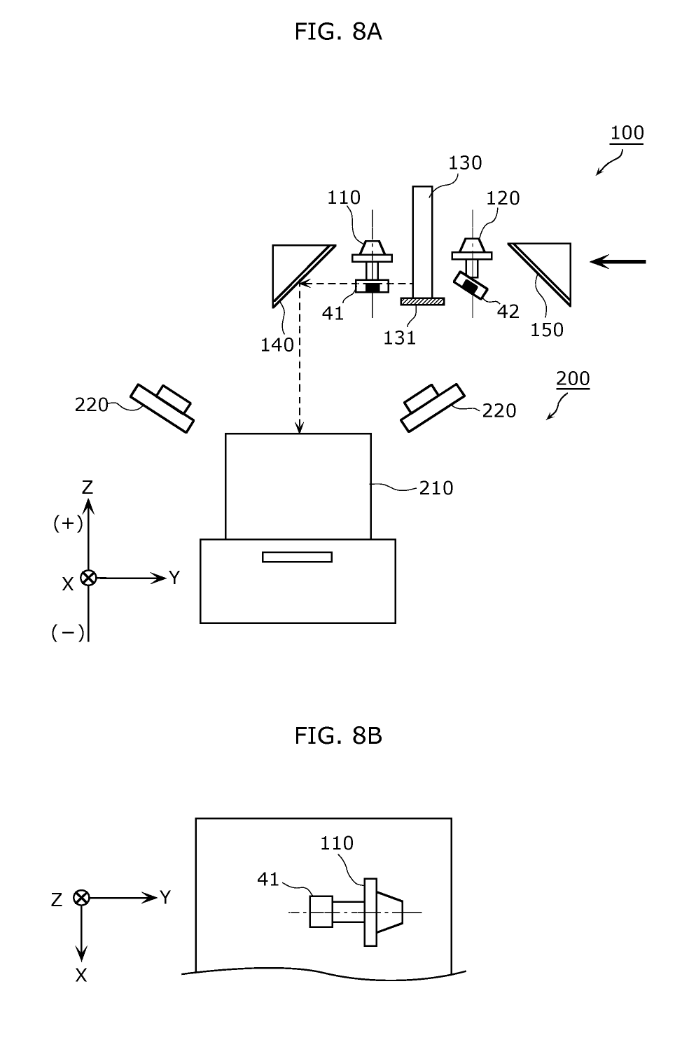

FIGS. 8A and 8B are diagrams for illustrating processes in which the head transportation controlling unit 24 according to the embodiment of the present invention transports the head 100 to place the first region above the imaging unit 210.

As shown in FIG. 8A, the head transportation controlling unit 24 transports the head 100 at least from the Y axis plus side toward the Y axis minus side, that is, in a direction from the component supplying unit 300 toward the board 30 to place the first region in the first reflecting unit 140 above the imaging unit 210.

In the case where the imaging unit 210 is not transported, the head 100 may be horizontally transported (XY transportation) to be positioned above the imaging unit 210.

Next, turning back to FIG. 6, the illumination controlling unit 21 causes the first illuminating unit 130 to illuminate the first region (S106). Moreover, in this case, the illumination controlling unit 21 causes the second illuminating unit 220 to maintain a non-illuminating state or to stop illumination.

That is, as shown in FIG. 8A, the illumination controlling unit 21 causes the first illuminating unit 130 to illuminate the side surface of the first component 41 with light to cause the light from the first illuminating unit 130 to be reflected by the first region in the first reflecting unit 140 toward the imaging unit 210. Moreover, in order not to allow the light from the second illuminating unit 220 to enter the imaging unit 210, the illumination controlling unit 21 causes the second illuminating unit 220, when the second illuminating unit 220 is in a non-illuminating state, to maintain the non-illuminating state, and when the second illuminating unit 220 is in an illuminating state, to stop the illumination.

Next, turning back to FIG. 6, the imaging controlling unit 22 causes the imaging unit 210 to capture the image of the first region in the first reflecting unit 140 to obtain the image of the side surface of the first component 41 (S108).

That is, the imaging controlling unit 22 causes the imaging unit 210 to capture the image of the first region to obtain the image of the side surface of the first component 41 as shown in FIG. 8B. It is to be noted that the imaging controlling unit 22 may cause the imaging unit 210 to simultaneously capture an image of the side surfaces of the plural first components 41 (four components in this embodiment) held by the plural first nozzles 110, or may cause the imaging unit 210 to capture an image of the side surfaces of some of the first components 41.

Next, the head transportation controlling unit 24 transports the head 100 to place the third region above the imaging unit 210 (S110).

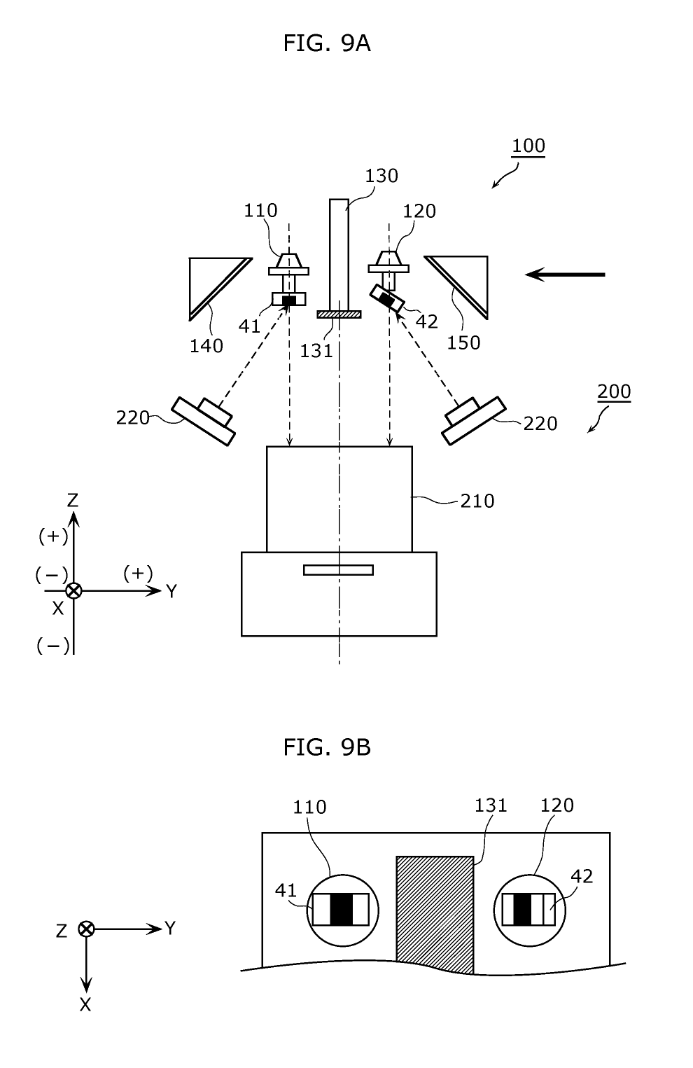

FIGS. 9A and 9B are diagrams for illustrating processes in which the head transportation controlling unit 24 according to the embodiment of the present invention transports the head 100 to place the third region above the imaging unit 210.

As shown in FIG. 9A, given that the direction from the component supplying unit 300 toward the board 30 positioned at the center of the Y axis direction is the Y axis minus direction, the head transportation controlling unit 24 further transports the head 100 in the Y axis minus direction to place the third region including the bottom surface of the first component 41 and the bottom surface of the second component 42 above the imaging unit 210.

Next, turning back to FIG. 6, the illumination controlling unit 21 causes the second illuminating unit 220 to illuminate the third region (S112). Moreover, in this case, the illumination controlling unit 21 causes the first illuminating unit 130 to stop the illumination.

That is, as shown in FIG. 9A, the illumination controlling unit 21 causes the second illuminating unit 220 to illuminate the bottom surface of the first component 41 and the bottom surface of the second component 42 with light, so that the light reflected by the bottom surface of the first component 41 and the bottom surface of the second component 42 enters the imaging unit 210. Moreover, in order not to allow the light from the first illuminating unit 130 to enter the imaging unit 210, the illumination controlling unit 21 causes the first illuminating unit 130 to stop the illumination.

Next, turning back to FIG. 6, the imaging controlling unit 22 causes the imaging unit 210 to capture the image of the third region to obtain the images of the bottom surface of the first component 41 and the bottom surface of the second component 42 (S114).

That is, the imaging controlling unit 22 causes the imaging unit 210 to capture the image of the third region to obtain the image of the bottom surface of the first component 41 and the bottom surface of the second component 42 as shown in FIG. 9B. It is to be noted that the imaging controlling unit 22 may cause the imaging unit 210 to simultaneously capture an image of the bottom surfaces of the plural first components 41 (four components in this embodiment) held by the plural first nozzles 110 and the bottom surfaces of the plural second components 42 (four components in this embodiment) held by the plural second nozzles 120, or may cause the imaging unit 210 to capture an image of the side surfaces of some of the first components 41 and the second components 42.

Next, the head transportation controlling unit 24 transports the head 100 to place the second region above the imaging unit 210 (S116).

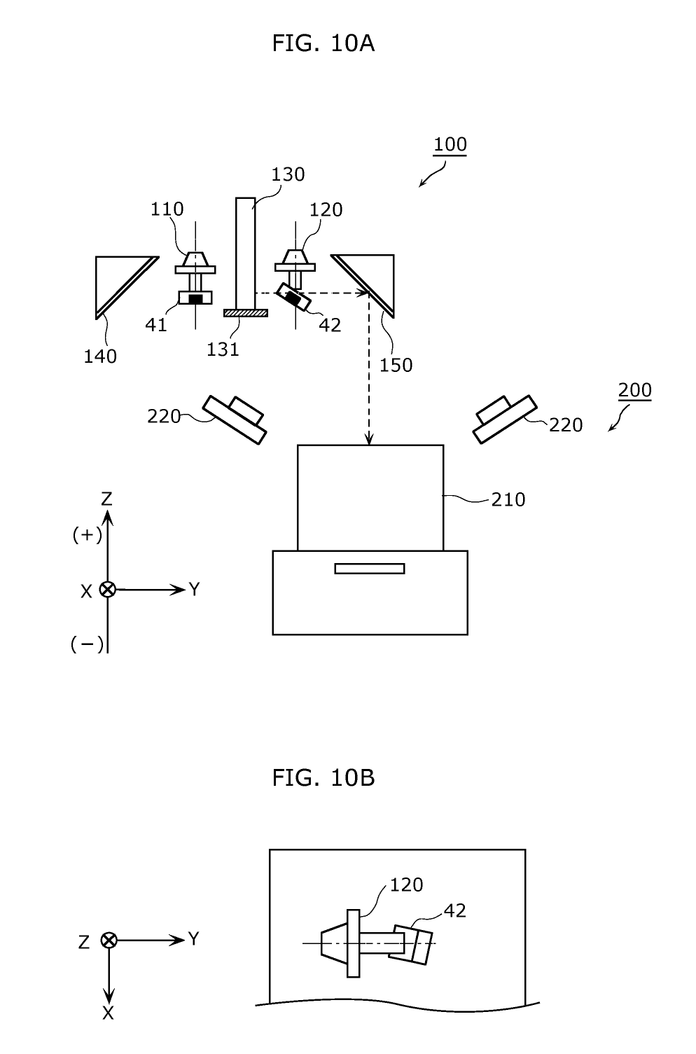

FIGS. 10A and 10B are diagrams for illustrating processes in which the head transportation controlling unit 24 according to the embodiment of the present invention transports the head 100 to place the second region above the imaging unit 210.

As shown in FIG. 10A, the head transportation controlling unit 24 further transports the head 100 in the Y axis minus direction which is the direction toward the board 30 to place the second region in the second reflecting unit 150 above the imaging unit 210.

Next, turning back to FIG. 6, the illumination controlling unit 21 causes the first illuminating unit 130 to illuminate the second region (S118). Moreover, in this case, the illumination controlling unit 21 causes the second illuminating unit 220 to stop the illumination.

That is, as shown in FIG. 10A, the illumination controlling unit 21 causes the first illuminating unit 130 to illuminate the side surface of the second component 42 with light to cause the light from the first illuminating unit 130 to be reflected by the second region in the second reflecting unit 150 toward the imaging unit 210. Moreover, in order not to allow the light from the second illuminating unit 220 to enter the imaging unit 210, the illumination controlling unit 21 causes the second illuminating unit 220 to stop the illumination.

Next, turning back to FIG. 6, the imaging controlling unit 22 causes the imaging unit 210 to capture the image of the second region in the second reflecting unit 150 to obtain the image of the side surface of the second component 42 (S120).

That is, the imaging controlling unit 22 causes the imaging unit 210 to capture the image of the second region to obtain the image of the side surface of the second component 42 as shown in FIG. 10B. It is to be noted that the imaging controlling unit 22 may cause the imaging unit 210 to simultaneously capture an image of the side surfaces of the plural second components 42 (four components in this embodiment) held by the plural second nozzles 120, or may cause the imaging unit 210 to capture an image of the side surfaces of some of the second components 42.

This is the end of the processes in which the controlling device 20 recognizes the postures of the first component 41 and the second component 42 held by the head 100.

As described above, with the component mounter 10 according to the embodiment of the present invention, the first illuminating unit 130 illuminates the side surface of the first component 41 and the side surface of the second component 42, the light is reflected by the first region in the first reflecting unit 140 or the second region in the second reflecting unit 150, and the imaging unit 210 captures the image of the first region or the second region to obtain the image of the side surface of the first component 41 or the side surface of the second component 42. With this, it is possible to capture the image of the side surface of the first component 41 or the second component 42 using the first illuminating unit 130 and the first reflecting unit 140 or the second reflecting unit 150. Therefore, there is no need to provide the imaging unit 210 for the head 100. Moreover, there is no need to move a nozzle up and down when capturing the image of the side surface of the first component 41 or the second component 42. Accordingly, with the component mounter 10, it is possible to recognize a posture of a component, with a simple structure, while suppressing a tact loss.

Moreover, when the imaging unit 210 captures the image of the first region or the second region, the component mounter 10 causes the first illuminating unit 130 to be in an illuminating state and causes the second illuminating unit 220 to maintain a non-illuminating state or to be in a non-illuminating state, to capture the image of the side surface of the first component 41 or the side surface of the second component 42. Moreover, when the imaging unit 210 captures the image of the third region, the component mounter 10 causes the second illuminating unit 220 to be in an illuminating state and causes the first illuminating unit 130 to be in a non-illuminating state, to capture the image of at least one of the bottom surface of the first component 41 and the bottom surface of the second component 42. That is, the image of the side surface of the component can be captured using the imaging unit 210 provided for the purpose of capturing the image of the bottom surface of the component. Moreover, by selectively using the illuminating units necessary for capturing the images, the images of the side surface and the bottom surface of the component can be captured using one imaging unit 210. Accordingly, with the component mounter 10, it is possible to recognize a posture of a component, with a simple structure, while suppressing a tact loss.

Moreover, when transporting the head 100 to place the first region above the imaging unit 210, the component mounter 10 causes the first illuminating unit 130 to illuminate the first region and causes the second illuminating unit 220 to maintain a non-illuminating state or to stop illumination, to cause the imaging unit 210 to capture the image of the first region. Moreover, when transporting the head 100 to place the third region above the imaging unit 210, the component mounter 10 causes the second illuminating unit 220 to illuminate the third region and causes the first illuminating unit 130 to stop the illumination, to cause the imaging unit 210 to capture the image of the third region. Moreover, when transporting the head 100 to place the second region above the imaging unit 210, the component mounter 10 causes the first illuminating unit 130 to illuminate the third region and causes the second illuminating unit 220 to stop the illumination, to cause the imaging unit 210 to capture the image of the second region. That is, the component mounter 10 transports the head 100 and sequentially captures the images of the side surface of the first component 41, the bottom surface of the first component 41, the bottom surface of the second component 42, and the side surface of the second component 42. Here, when the image of the side surfaces and the bottom surfaces of the first component 41 and the second component 42 are simultaneously captured, a viewing field is increased and the illumination light is polarized, resulting in a decrease in a capturing accuracy. Therefore, the sequential capturing of the images of the side surfaces and the bottom surfaces of the first component 41 and the second component 42 can improve the capturing accuracy. Moreover, transportation of the head 100 within the intervals of the capturing period of the imaging unit 210 does not generate a tact loss that can be caused by the transportation of the head 100. Accordingly, with the component mounter 10, it is possible to accurately recognize a posture of a component, with a simple structure, while suppressing a tact loss.

Moreover, the component mounter 10 includes, between the first illuminating unit 130 and the imaging unit 210, the blocking plate 131 that is an opaque and non-reflective member which is opaque for blocking transmission of light from the first illuminating unit 130 and non-reflective for blocking reflection of light toward the first illuminating unit 130. That is, the blocking plate 131 prevents the light from the first illuminating unit 130 from directly entering the imaging unit 210 and prevents the light from being reflected by the first illuminating unit 130 and entering the imaging unit 210. Thus, with the component mounter 10, the image of the component can be accurately captured by the imaging unit 210. Therefore, it is possible to accurately recognize a posture of a component, with a simple structure, while suppressing a tact loss.

Moreover, the component mounter 10 transports the imaging unit 210 close to a position at which the head 100 has picked up or picks up a component from the component supplying unit 300. With this, after the head 100 has picked up a component from the component supplying unit 300, the component mounter 10 can transport the head 100 above the imaging unit 210 and cause the imaging unit 210 to capture the image of the component picked up by the head 100. Accordingly, it is possible to recognize a posture of a component, with a simple structure, while suppressing a tact loss. Moreover, after the head 100 has mounted the component on the board 30, it is possible to transport the head above the imaging unit 210 in the middle of transportation for picking up a component and to cause the imaging unit 210 to capture an image of the state of the head 100 to check whether or not the component is still held by the head. In particular, although a recognition error may be caused by solder and others which is attached to a tip of the nozzle when the head 100 mounts a component on the board 30, the recognition error can be prevented by causing the imaging unit 210 to capture the image of the suctioning state for the component. Accordingly, it is possible to recognize a posture of a component, with a simple structure, while suppressing a tact loss.

Moreover, with the head 100 according to the embodiment of the present invention, the first illuminating unit 130 illuminates the side surface of the first component 41 and the side surface of the second component 42, and the light is reflected by the first region in the first reflecting unit 140 or the second region in the second reflecting unit 150 toward the imaging unit 210. With this, since the image of the side surface of the first component 41 or the side surface of the second component 42 can be obtained by capturing the first region or the second region by the imaging unit 210, it is not necessary to provide the imaging unit 210 for the head 100. Moreover, there is no need to move the nozzle up and down when capturing the image of the side surface of the first component 41 or the second component 42. Accordingly, use of the head 100 enables the component mounter 10 to be capable of recognizing a posture of a component, with a simple structure, while suppressing a tact loss.

Moreover, with the component posture recognition method according to the embodiment of the present invention, the first illuminating unit 130 illuminates the side surface of the first component 41 and the side surface of the second component 42, the light is reflected by the first region in the first reflecting unit 140 or the second region in the second reflecting unit 150, and the imaging unit 210 captures the image of the first region or the second region to obtain the image of the side surface of the first component 41 or the side surface of the second component 42. Accordingly, it is possible to capture the image of the side surface of the first component 41 or the second component 42 using the first illuminating unit 130 and the first reflecting unit 140 or the second reflecting unit 150. Therefore, there is no need to provide the imaging unit 210 for the head 100. Moreover, there is no need to move the nozzle up and down when capturing the image of the side surface of the first component 41 or the second component 42. Thus, with the component posture recognition method, it is possible to recognize the posture of the component while suppressing a tact loss using the component mounter 10 having a simple structure.

It is to be noted that the present invention can be implemented not only as such a component posture recognition method, but as a program for causing a computer to execute the characteristic processes included in the component posture recognition method or an integrated circuit. Such a program can naturally be distributed through recording media such as CD-ROMs or via communication media such as the Internet.

Although the component mounter 10 according to the embodiment of the present invention has been described, the present invention is not limited to this embodiment.

It is to be understood that the disclosed embodiment is illustrative and not restrictive in all respects. The scope of the present invention is indicated not by the above description but by the claims, and is intended to include equivalents of the claims and all modifications within the scope of the claims.

### INDUSTRIAL APPLICABILITY

The present invention can be used in a component mounter and others which is capable of, with a simple structure, recognizing a posture of a component while suppressing a tact loss.

### REFERENCE SIGNS LIST

10 Component mounter
20 Controlling device
21 Illumination controlling unit
22 Imaging controlling unit
23 Imaging transportation controlling unit
24 Head transportation controlling unit
30 Board
41 First component
42 Second component
100 Head
110 First nozzle
120 Second nozzle
130 First illuminating unit
131 Blocking plate
140 First reflecting unit
150 Second reflecting unit
200 Imaging device
210 Imaging unit
220 Second illuminating unit
300 Component supplying unit
310 Component feeder

1. A component mounter which mounts a first component and a second component on a board, the component mounter comprising:
a head including a first nozzle for holding the first component and a second nozzle for holding the second component; and
an imaging unit configured to capture an image of the first component and an image of the second component,
wherein the head includes:
a first illuminating unit disposed between the first nozzle and the second nozzle and configured to illuminate a side surface of the first component and a side surface of the second component with light;
a first reflecting unit disposed lateral to the first nozzle such that the first nozzle is positioned between the first illuminating unit and the first reflecting unit and configured to reflect the light from the first illuminating unit, the light reflected off a first region of the first reflecting unit and toward the imaging unit; and
a second reflecting unit disposed lateral to the second nozzle such that the second nozzle is positioned between the first illuminating unit and the second reflecting unit and configured to reflect the light from the first illuminating unit, the light reflected off a second region of the second reflecting unit and toward the imaging unit, and
the imaging unit is configured to capture an image of the first region in the first reflecting unit or the second region in the second reflecting unit to obtain an image of the side surface of the first component or the side surface of the second component.

2. The component mounter according to claim 1, further comprising:
a second illuminating unit configured to illuminate a third region including at least one of a bottom surface of the first component and a bottom surface of the second component; and
an illumination controlling unit configured to cause the first illuminating unit and the second illuminating unit to start illumination or to stop illumination,
wherein the illumination controlling unit is configured to
(a) cause the first illuminating unit to be in an illuminating state and cause the second illuminating unit to be in a non-illuminating state when the imaging unit captures the image of the first region or the second region; and
(b) cause the second illuminating unit to be in an illuminating state and cause the first illuminating unit to be in a non-illuminating state when the imaging unit captures an image of the third region.

3. The component mounter according to claim 2, further comprising:
a head transportation controlling unit configured to transport the head; and
an imaging controlling unit configured to cause the imaging unit to capture an image,
wherein, when the head transportation controlling unit transports the head to place the first region above the imaging unit, the illumination controlling unit is configured to cause the first illuminating unit to illuminate the first region and cause the second illuminating unit to maintain a non-illuminating state or to stop illumination, and the imaging controlling unit is configured to cause the imaging unit to capture the image of the first region,
when the head transportation controlling unit transports the head to place the third region above the imaging unit, the illumination controlling unit is configured to cause the second illuminating unit to illuminate the third region and cause the first illuminating unit to stop illumination, and the imaging controlling unit is configured to cause the imaging unit to capture the image of the third region, and
when the head transportation controlling unit transports the head to place the second region above the imaging unit, the illumination controlling unit is configured to cause the first illuminating unit to illuminate the second region and cause the second illuminating unit to stop illumination, and the imaging controlling unit is configured to cause the imaging unit to capture the image of the second region.

4. The component mounter according to claim 1, further comprising
an opaque and non-reflective member disposed between the first illuminating unit and the imaging unit, the member being opaque for blocking transmission of light from the first illuminating unit, and non-reflective for blocking reflection of light toward the first illuminating unit.

5. The component mounter according to claim 1, further comprising:
a component supplying unit including components and configured to supply the components to the head; and
an imaging transportation controlling unit configured to transport the imaging unit along the component supplying unit,
wherein the imaging transportation controlling unit is configured to transport the imaging unit close to a position at which the head has picked up or picks up a component using suction from the component supplying unit.

6. A head which includes a first nozzle for holding a first component and a second nozzle for holding a second component and is provided in a component mounter which captures an image of the first component and an image of the second component using an imaging unit and mounts the first component and the second component on a board, the head comprising:
a first illuminating unit disposed between the first nozzle and the second nozzle and configured to illuminate a side surface of the first component and a side surface of the second component with light;
a first reflecting unit disposed lateral to the first nozzle such that the first nozzle is positioned between the first illuminating unit and the first reflecting unit and configured to reflect the light from the first illuminating unit, the light reflected off a first region of the first reflecting unit and toward the imaging unit; and
a second reflecting unit disposed lateral to the second nozzle such that the second nozzle is positioned between the first illuminating unit and the second reflecting unit and configured to reflect the light from the first illuminating unit, the light reflected off a second region of the second reflecting unit and toward the imaging unit.

7. A component posture recognition method in which a component mounter recognizes postures of a first component and a second component, the component mounter including a head having a first nozzle for holding the first component and a second nozzle for holding the second component, and an imaging unit which captures an image of the first component and an image of the second component, the method comprising:
(a) causing a first illuminating unit to illuminate a side surface of the first component with light to cause a first reflecting unit to reflect the light from the first illuminating unit, the light reflected off a first region of the first reflecting unit and toward the imaging unit, the first illuminating unit being disposed between the first nozzle and the second nozzle, and the first reflecting unit being disposed lateral to the first nozzle such that the first nozzle is positioned between the first illuminating unit and the first reflecting unit;
(b) causing the imaging unit to capture an image of the first region in the first reflecting unit to obtain an image of the side surface of the first component;
(c) causing the first illuminating unit to illuminate a side surface of the second component with light to cause a second reflecting unit to reflect the light from the first illuminating unit, the light reflected off a second region of the second reflecting unit and toward the imaging unit, and the second reflecting unit being disposed lateral to the second nozzle such that the second nozzle is positioned between the first illuminating unit and the second reflecting unit; and
(d) causing the imaging unit to capture an image of the second region in the second reflecting unit to obtain an image of the side surface of the second component.

8. The component posture recognition method according to claim 7, further comprising
transporting the head to place the first region above the imaging unit,
wherein step (a) includes causing the first illuminating unit to illuminate the first region and causing a second illuminating unit configured to illuminate a third region including at least one of a bottom surface of the first component and a bottom surface of the second component to maintain a non-illuminating state or to stop illumination, and
the component posture recognition method further comprises:
transporting the head to place the third region above the imaging unit;
causing the second illuminating unit to illuminate the third region and causing the first illuminating unit to stop illumination;
causing the imaging unit to capture an image of the third region; and
transporting the head to place the second region above the imaging unit,
wherein step (c) includes causing the first illuminating unit to illuminate the second region and causing the second illuminating unit to stop illumination.
